(19) United States
(12) Patent Application Publication
(10) Pub. No.: US 2025/0083964 A1
(43) Pub. Date: Mar. 13, 2025

(54) CARBON NANOTUBE WATER DISPERSION, CARBON NANOTUBE UNWOVEN CLOTH, AND METHODS OF PRODUCING THE SAME

(71) Applicant: Shin-Etsu Chemical Co., Ltd., Tokyo (JP)

(72) Inventors: Toshio SHIOBARA, Tokyo (JP); Ryo TANAKA, Annaka-shi (JP)

(73) Assignee: Shin-Etsu Chemical Co., Ltd., Tokyo (JP)

(21) Appl. No.: 18/827,155

(22) Filed: Sep. 6, 2024

(30) Foreign Application Priority Data
Sep. 7, 2023 (JP) 2023-145602

(51) Int. Cl. C01B 32/174

(52) U.S. Cl. CPC C01B 32/174

(57) ABSTRACT

Provided is a carbon nanotube water dispersion which is suitable for producing a highly-purified carbon nanotube unwoven cloth as well as a highly-purified carbon nanotube unwoven produced from the carbon nanotube water dispersion. The carbon nanotube water dispersion contains 100 parts by mass of water, 0.001 parts by mass or more of a basic compound, and 0.001 parts by mass or more of a cholic acid derivative.

### BACKGROUND OF THE INVENTION

### Field of the Invention

The present invention relates to a carbon nanotube water dispersion, a carbon nanotube unwoven cloth and methods of producing these.

### Background Art

It is known that a carbon nanotube nonwoven can be directly produced from carbon nanotube agglomerates generated in a gas phase. Still, it is difficult to develop a machine that directly use carbon nanotubes as nonwoven cloth material, where such carbon nanotubes are typically generated through high-temperature reactions in the presence of hydrogen gas, and the resulting nonwoven fabric unintentionally exhibits anisotropy behavior in terms of strength (See JP-A-2015-007304, JP-A-2013-241723, JP-A-2016-065350 and JP-A-2016-102047).

As an alternative method of producing nonwoven fabrics of carbon nanotubes, apart from the vapor phase method, a wet method is known. This method involves using a dispersion liquid in which carbon nanotubes are dispersed in an organic solvent or in an aqueous solution. In the wet method of utilizing a carbon nanotube dispersion, the presence of a dispersant such as an ionic liquid or surfactant is crucial for achieving uniform dispersion of carbon nanotube aggregates in either water or in an organic solvent. For example, WO-A-2018/179760 describes a carbon nanotube dispersion liquid that utilizes dispersants of, for example, an organic acid sodium salt and an organic acid ammonium salt.

JP-A-2014-189932 shows a method of forming a sheet by filtrating a water dispersion that contains fine cellulose fibers and carbon nanotubes.

Additionally, JP-A-2015-178446 discloses a method for obtaining a carbon nanotube film from a carbon nanotube dispersion that contains sodium deoxycholate as a dispersant.

### SUMMARY OF THE INVENTION

However, an ionic liquid has an issue with chemical stability, and the method as described in JP-A-2015-178446 has a problem in that sodium ions unintentionally remain in the carbon nanotube film (carbon nanotube unwoven cloth). A method of subjecting a carbon nanotube unwoven cloth to a high-temperature heat treatment may be used for removing a dispersant from the carbon nanotube unwoven cloth having been produced using the wet method. However, this method is problematic in that such high-temperature heat treatment may cause oxidative deterioration in the carbon nanotubes. Accordingly, it has been difficult to reduce the amount of dispersant contained in the carbon nanotube unwoven cloth and to make a highly-purified carbon nanotube.

It is therefore an object of the present invention to provide a carbon nanotube water dispersion and a method of producing the dispersion, which are suitable for producing a highly-purified carbon nanotube unwoven cloth. It is also an object of the present invention to provide a highly-purified carbon nanotube unwoven cloth having been produced using the carbon nanotube water dispersion, and a method of producing such carbon nanotube unwoven cloth.

The inventors of the present invention diligently conducted a series of studies to solve the aforementioned problems, and completed the invention by finding that the carbon nanotube water dispersion described below was able to achieve the above object.

That is, the present invention provides a carbon nanotube water dispersion as well as other related inventions, which are as defined below.

<1> A carbon nanotube water dispersion comprising:
100 parts by mass of water;
0.001 parts by mass or more of a basic compound;
0.001 parts by mass or more of a cholic acid derivative; and
0.01 to 10.0 parts by mass of carbon nanotubes,
wherein an amount by mass of the cholic acid derivative with respect to an amount by mass of the carbon nanotubes is 0.1 to 5.0.
   <2> The carbon nanotube water dispersion according to <1>, wherein the cholic acid derivative is one or more selected from the group consisting of α-muricholic acid, β-muricholic acid, cholic acid, deoxycholic acid, ursodeoxycholic acid, hyodeoxycholic acid, chenodeoxycholic acid, dehydrocholic acid, and lithocholic acid.
   <3> The carbon nanotube water dispersion according to <1> or <2>, wherein the basic compound is a nitrogen-containing compound.
   <4> The carbon nanotube water dispersion according to <3>, wherein the nitrogen-containing compound is ammonia.
   <5> The carbon nanotube water dispersion according to any one of <1> to <4>, wherein the carbon nanotube water dispersion has a thixotropic ratio of 50 to 1,000, wherein the thixotropic ratio is a ratio (η_{0.1}/η₁₀₀) of a viscosity (η_{0.1}) at a shear rate of 0.1 s⁻¹ to a viscosity (η₁₀₀) at a shear rate of 100 s⁻¹, wherein the viscosities (η_{0.1}, η₁₀₀) are measured at 25° C. using a cone-plate type rotary viscometer described in JIS K 7117-2:1999.
   <6> A method of producing a carbon nanotube water dispersion comprising the steps of:
preparing a dispersing aqueous solution containing:
   100 parts by mass of water;
   0.001 parts by mass or more of a basic compound; and
   0.001 parts by mass or more of a cholic acid derivative; and
dispersing 0.01 to 10.0 parts by mass of carbon nanotubes into the dispersing aqueous solution such that an additive amount by mass of the cholic acid derivative to an amount by mass of the carbon nanotubes is 0.1 to 5.0.
   <7> The method according to <6>, wherein the step of preparing a dispersing aqueous solution comprises
1) adding 0.001 parts by mass or more of a basic compound into 100 parts by mass of water and mixing the ingredients to prepare a basic aqueous solution having a pH of 8 to 12; and
2) dissolving 0.001 parts by mass or more of a cholic acid derivative into the basic aqueous solution to prepare a dispersing aqueous solution.
   <8> A method of producing a carbon nanotube unwoven cloth comprising the steps of:
4) applying the carbon nanotube water dispersion according to any one of <1> to <5> to a supporting body by a thickness of 5 mm or less, and removing water in a drying oven to produce a carbon nanotube thin film; and
5) separating the carbon nanotube thin film obtained in the step 4) from the supporting body and subjecting the thin film to a heat treatment of 250 to 500° C. at atmospheric pressure or to a heat treatment of 150 to 500° C. at a pressure less than the atmospheric pressure,
wherein the carbon nanotube unwoven cloth contains from 0% to less than 10% by mass of the cholic acid derivative.
   <9> The method according to <8>, wherein the heat treatment is performed in an inert gas.
   <10> A carbon nanotube unwoven cloth comprising a sodium atom content of less than or equal to 1.0% by mass.
   <11> The carbon nanotube unwoven cloth according to <10>, wherein the carbon nanotube unwoven cloth has a tensile strength ratio, as defined by a ratio of a longitudinal tensile strength to a lateral tensile strength, of 0.95 to 1.05.

The carbon nanotube water dispersion of the present invention has an excellent coating property, and employs a cholic acid derivative as a dispersant which can be removed therefrom within a temperature range that does not cause the carbon nanotube to be oxidized or deteriorated. The carbon nanotube water dispersion of the present invention may therefore be suitably used for, particularly, producing a highly-purified carbon nanotube unwoven cloth. The carbon nanotube water dispersion of the present invention can also produce a carbon nanotube unwoven cloth that does not have anisotropy in terms of strength using relatively a simple machine.

### BRIEF DESCRIPTION OF THE DRAWINGS

FIG. 1 shows a schematic diagram illustrating a system for measuring the transmission loss.

### DETAILED DESCRIPTION OF THE INVENTION

The present invention is described in detail hereunder.

### [Carbon Nanotube Water Dispersion]

The carbon nanotube water dispersion as used herein refers to a dispersion in which carbon nanotubes are dispersed in a water mixture that contains a cholic acid derivative and a basic compound. The ingredients contained in the carbon nanotube water dispersion of the present invention will be respectively explained hereafter.

### Carbon Nanotube

The carbon nanotubes may be single-walled carbon nanotubes, multi-walled carbon nanotubes or a mixture of the single-walled and multi-walled carbon nanotubes. Further, the method of producing carbon nanotubes is not particularly limited, and carbon nanotubes produced by a known method or those that are commercially available may be used. While no specific restrictions are imposed on the shape of the carbon nanotube, it is preferred that it has a diameter of 50 nm or less and a length of 2 mm or less in terms of the strength of the carbon nanotube unwoven cloth when the carbon nanotubes are used for producing the carbon nanotube unwoven cloth which will be described hereafter.

The carbon nanotubes may be added into the water dispersion in an amount of 0.01 to 10.0 parts by mass, preferably 0.05 to 5.0 parts by mass, and more preferably 0.1 to 2.5 parts by mass per 100 parts by mass of water.

### Cholic Acid Derivative

The present invention is unique in that a cholic acid derivative is used as a dispersant. The term “cholic acid derivative” as used herein is a collective term which refers to the cholic acid as well as compounds that differ from cholic acid in the presence or absence and/or the steric position of substituents. In the present invention, a salt of cholic acid derivative such as sodium cholate is not included in the scope of the cholic acid derivative.

Examples of the cholic acid derivative include α-muricholic acid, β-muricholic acid, cholic acid, deoxycholic acid, ursodeoxycholic acid, hyodeoxycholic acid, chenodeoxycholic acid, dehydrocholic acid, and lithocholic acid. Of these, deoxycholic acid is preferred.

The amount of cholic acid derivative to be added thereinto is 0.001 parts by mass or more per 100 parts by mass of water. The upper limit thereof may be optimized by the amount of carbon nanotubes in the dispersion.

The compounding ratio of the cholic acid derivative to the carbon nanotubes in terms of mass ratio may be 0.10 to 5.0, preferably 0.20 to 3.0, and more preferably 0.50 to 2.0.

### Basic Compound

It is preferred that the basic compound be a nitrogen-containing compound, and particularly preferred examples of the nitrogen-containing compound include a nitrogen-containing compound that is water soluble and has a boiling point of preferably 200° C. or less, more preferably 150° C. or less. Specific examples of the basic compound include an organic amine derivative and ammonia. Any organic amine derivative that is soluble in water may be used. Examples of the organic amine derivative include low molecular weight amine compounds such as monomethylamine, dimethylamine, trimethylamine and ethylenediamine. Of these basic compounds, ammonia is preferred.

The basic compound is added in an amount of 0.001 parts by mass or more per 100 parts by mass of water. The upper limit of the amount of the basic compound to be added is not particularly limited as long as the solution at 25° C. exhibits a pH within a range of 8 to 12.

### [Method of Producing Carbon Nanotube Water Dispersion]

The carbon nanotube water dispersion of the present invention can be produced by dispersing carbon nanotubes in a water mixture that contains a cholic acid derivative and a basic compound.

The term “dispersing aqueous solution” as used herein refers to a mixture of water, a cholic acid derivative and a basic compound.

The dispersing aqueous solution may be prepared by adding a cholic acid derivative and a basic compound simultaneously into water and mixing them, or the solution may be prepared by adding and mixing the ingredients in a separate manner.

The carbon nanotube water dispersion of the present invention may be produced by a method having the steps of, for example:
preparing a dispersing aqueous solution containing: 100 parts by mass of water; 0.001 parts by mass or more of a basic compound; and 0.001 parts by mass or more of a cholic acid derivative; and
dispersing 0.01 to 10.0 parts by mass of carbon nanotubes into the dispersing aqueous solution such that an additive amount by mass of the cholic acid derivative to the amount by mass of carbon nanotube is 0.1 to 5.0 (parts by mass/parts by mass).

The carbon nanotube water dispersion of the present invention may preferably be produced by a method having the steps 1) to 3) of:
1) adding 0.001 parts by mass or more of a basic compound into 100 parts by mass of water and mixing the ingredients to prepare a basic aqueous solution having a pH of 8 to 12;
2) dissolving 0.001 parts by mass or more of a cholic acid derivative into the basic aqueous solution to prepare a dispersing aqueous solution; and
3) dispersing 0.01 to 10.0 parts by mass of carbon nanotubes into the dispersing aqueous solution such that an additive amount by mass of the cholic acid derivative to the amount by mass of carbon nanotube is 0.1 to 5.0 (parts by mass/parts by mass).

Alternatively, the carbon nanotube water dispersion of the present invention may be produced using the following steps 1′) and 2′) in place of the steps 1) and 2) as shown above to prepare a dispersing aqueous solution, and then performing the step 3), wherein the steps 1′) and 2′) are defined as:
1′) a step of adding 0.001 parts by mass or more of a cholic acid derivative into 100 parts by mass of water and mixing the ingredients to prepare a dispersing solution of the cholic acid derivative; and
2′) a step of adding 0.001 parts by mass or more of a basic compound into the dispersing solution of the cholic acid derivative and mixing the ingredients to prepare a dispersing aqueous solution having a pH of 8 to 12.

The present invention is based on the finding that a basic aqueous solution having a pH of 8 to 12, preferably a pH of 8.5 to 11.5 may be used as a dispersant of carbon nanotube to allow a poorly water-soluble cholic acid derivative to be present in a solubilized state in a carbon nanotube water dispersion, and therefore the basic aqueous solution serves as a dispersant for carbon nanotubes. The cholic acid derivative may be dissolved in any desired proportions as long as the solution is basic, specifically at a pH of 8 more, thus allowing a user to have freedom of choice with respect to the additive amount of the cholic acid derivative in accordance with the amount of carbon nanotubes in the dispersion.

In the step 1) of preparing a basic aqueous solution, a basic compound is added in an amount of 0.001 parts by mass or more into 100 parts by mass of water, and then the ingredients are mixed to obtain a basic aqueous solution having a pH of 8 to 12. The pH of the basic aqueous solution is a value at 25° C. The upper limit of the additive amount of the basic compound may be suitably determined based on the type of basic compound as long as the aqueous solution has a pH within the range of 8 to 12. For example, when ammonia is used as a basic compound, this ammonia may be added in an amount of 0.001 to 28 parts by mass, preferably 0.01 to 5 parts by mass, per 100 parts by mass of water. Moreover, when a low molecular weight amine compound is used as a basic compound, this low molecular weight amine compound may be added in an amount of 0.001 to 10 parts by mass, preferably 0.01 to 5 parts by mass, per 100 parts by mass of water.

In the step 2) of preparing a dispersing aqueous solution, a cholic acid derivative is added in an amount of 0.001 parts by mass or more and dissolved into the basic aqueous solution prepared in the step 1) to prepare a dispersing aqueous solution. Various types of stirrers may be used for dissolving the cholic acid derivative in the step 2).

In the step 1′) of preparing a dispersing solution of the cholic acid derivative, a cholic acid derivative is added in an amount of 0.001 parts by mass or more and mixed into 100 parts by mass of water. In the step 1′), the cholic acid derivative is present in a state that is dispersed in water.

In the step 2′) of preparing a dispersing aqueous solution, a basic compound is added in an amount of 0.001 parts by mass or more and mixed into the dispersing solution of the cholic acid derivative prepared in the step 1′) to obtain a dispersing aqueous solution having a pH of 8 to 12. The pH of the dispersing aqueous solution is a value at 25° C. The upper limit of the additive amount of the basic compound may be suitably determined based on the type of basic compound as long as the cholic acid derivative is dissolved such that the dispersing aqueous solution has a pH within the range of 8 to 12, and the limit is specifically as specified in the step 1). Various types of stirrers may be used for dissolving the cholic acid derivative in the step 2′).

In the step 3) of dispersing carbon nanotubes, these carbon nanotubes are added in an amount of 0.01 to 10.0 parts by mass into the dispersing aqueous solution prepared in the step 2) or 2′) such that an additive amount by mass of the cholic acid derivative to the amount by mass of carbon nanotube is 0.1 to 5.0 (parts by mass/parts by mass), and these carbon nanotubes are dispersed to prepare a carbon nanotube water dispersion.

Any known device may be used for the dispersing treatment. If necessary, there may be used dispersing treatments using, for example, ultrasonic sound, a jet mill and/or a high-shear mixer. Nevertheless, it is preferred that these treatments are performed to the extent of not impairing the characteristics of carbon nanotubes or fine fibers.

One type of dispersing treatment may be used alone, or a plurality of dispersing treatments may be used in combination.

In general, when applying a liquid material using a coater, it is desirable to use a highly thixotropic material as a characteristic of liquid resin that demonstrates lower viscosity in regions of higher shear rate while becoming more viscous in regions of lower shear rate.

For this reason, when producing a carbon nanotube unwoven cloth according to the present invention, it is preferred that the carbon nanotube water dispersion exhibits a thixotropic ratio of 50 to 1,000, more preferably 100 to 1,000.

The term “thixotropic ratio” as used herein refers to a ratio (η_{0.1}/η₁₀₀) of a viscosity (η_{0.1}) at a shear rate of 0.1 s⁻¹ to a viscosity (η₁₀₀) at a shear rate of 100 s⁻¹ that are measured at 25° C. using a cone-plate type rotary viscometer described in JIS K 7117-2:1999.

A carbon nanotube water dispersion having a thixotropic ratio of 50 to 1,000 is preferable because it allows the film to easily maintain the shape as it is at the time when the carbon nanotube water dispersion is applied to a supporting body, and is less likely to produce a difference in coating thickness at the central and end portions, thus resulting in a uniform film.

It is also preferred that the viscosity (η₁₀₀) at the shear rate of 100 s⁻¹ be 0.1 to 5 Pa·s, more preferably 0.2 to 2.5 Pa·s. It is also preferred that the viscosity (η_{0.1}) at the shear rate of 0.1 s⁻¹ be 10 to 5×10³ Pa·s, more preferably 50 to 1,000 Pa·s.

The viscosity and thixotropic ratio of the dispersion are determined by, for example, the mixing ratio of water and carbon nanotubes, and the type and amount of dispersant.

### [Carbon Nanotube Unwoven Cloth and Method of Producing the Same]

The carbon nanotube water dispersion of the present invention may be suitable used for producing a carbon nanotube unwoven cloth. The carbon nanotube unwoven cloth may be produced using, for example, a method having the steps of 4) and 5). The steps are defined as:
4) a step of applying the carbon nanotube water dispersion of the present invention, preferably a carbon nanotube water dispersion obtained in the steps 1) to 3), to a supporting body by a thickness of 5 mm or less, and removing water in a drying oven to produce a carbon nanotube thin film; and
5) a step of separating the carbon nanotube thin film obtained in the step 4) from the supporting body and subjecting the thin film to a heat treatment of 250 to 500° C. at atmospheric pressure or to a heat treatment of 150 to 500° C. at a pressure less than the atmospheric pressure to thereby remove the cholic acid derivative.

The supporting body preferably has a surface with a water contact angle of 120° or less, more preferably from 70° to 110° in respect of forming a thin film with no repellency from the water dispersion. The supporting body may have any shape such as a film or a plate which is non-limiting but when it is a film, the material of it is preferably a thermoplastic material having a softening temperature of 50° C. or more or a thermohardening resin. When the supporting body has a shape of a plate, stainless steel (SUS), aluminum and fiber reinforced plastic (FRP) or any other material which is not particularly limited may be used as long as such material is not deformed at a temperature for drying water. It is, however, preferred that the material be excellent in mold releasability such as the one on which fluorocarbon resin is coated. A supporting body whose surface is treated with plasma processing or ultraviolet treatment may be used when the water contact angle exceeds 120° or the material of the supporting body exhibits low wettability.

Examples of the supporting body include a film of, for example, polypropylene, polyethylene terephthalate, polyimide, polyethylene and fluorocarbon resin.

A coating device such as a roll coater, a gravure coater, a reverse coater, a slot die coater, a lip coater, a bladed roll coater or a blade coater may be used in the step 4) for coating the carbon nanotube water dispersion on the supporting body. Of these devices, devices capable of coating a thick film such as a slot die coater and a blade coater are preferred.

In the step 4), the carbon nanotube water dispersion of the present invention is applied to the supporting body using a coating device for forming a film such as those as listed above to form a carbon nanotube thin film having a predetermined thickness. For example, a slot die coater may be used to form a thin film by extruding the dispersion onto the supporting body by a predetermined thickness using a slot die.

After that, there is used a drying oven through which water content is removed. Any heating temperature and residence time in the oven may be used as long as water content can be removed but in normal cases, the water content can be sufficiently reduced by drying at 50 to 150° C. for 30 minutes to 10 hours.

The coating thickness of the dispersion onto the supporting body may be, depending on the mixing amount of the carbon nanotube, less than or equal to 5 mm, preferably 10 μm to 5 mm. A carbon nanotube water dispersion having been coated by the coating thickness of 10 μm to 5 mm may be subjected to water removal through the drying oven as shown above to thereby result in a carbon nanotube thin film having a thickness of 0.01 μm to 1 mm. A pressing roll or other devices may be used for tuning the film thickness after water removal for more uniformly conditioning the thickness of the carbon nanotube thin film.

The carbon nanotube thin film obtained in the step 4) may contain a cholic acid derivative and a basic compound. To remove these cholic acid derivative and basic compound contained in the carbon nanotube thin film, in the step 5), the carbon nanotube thin film is peeled off from the supporting body and is subjected to a heat treatment with a predetermined temperature.

In the step 5) of heat treatment, the carbon nanotube thin film peeled off from the supporting body may be directly put into a heat-treating furnace, but it is preferable to employ a method in which the carbon nanotube thin film, peeled off from the supporting body, is wound up on a cylindrical body with which the carbon nanotube thin film is put into the heat-treating furnace for heating. A cylindrical body of metal or ceramic material such as glass may be used therefor. It is preferred that the cylindrical body have (preferably a multiple of) through-holes having any suitable shapes on a sidewall of the cylindrical body.

The heat treatment may be performed within a temperature of 250 to 500° C. at atmospheric pressure or within a temperature of 150 to 500° C. at a pressure less than the atmospheric pressure. A heat treatment performed at a temperature exceeding 500° C. oxidize or deteriorate the carbon nanotubes, and therefore is unfavorable. The lower limit of the heat treatment temperature is a temperature that removes the cholic acid derivative and the basic compound, and the limit is set at equal to or higher than 250° C. in respect of productivity when the heat treatment is performed at atmospheric pressure while the limit is set at equal to or higher than 150° C. when the heat treatment is performed at less than atmospheric pressure, i.e., when the pressure of heat treatment system is reduced to less than one atmosphere (1013 hPa). The heat treatment temperature to be performed under atmospheric pressure is more preferably 250 to 450° C., even more preferably 300 to 400° C.

The heat treatment may be performed under an oxygen-containing atmosphere such as air atmosphere. It is, however, preferred that the treatment be performed under an inert gas atmosphere such as nitrogen atmosphere for preventing oxidation of carbon nanotube. It is particularly preferred that the treatment be performed under a pressure less than the atmospheric pressure. A carbon nanotube starts to oxidize itself over time at a temperature greater than 400° C. For this reason, although heat treatment may be performed under air atmosphere when the treatment is performed at a temperature less than 400° C. within a short period of time, it is preferred that the treatment be performed under an inert gas atmosphere if the heat treatment is performed at a temperature of higher than or equal to 400° C. or the treatment is performed for relatively a long period of time.

The heat-treating time depends on the heat treatment temperature, and is within the range of, for example, 0.5 to 50 hours, preferably 2 to 40 hours. Specifically, the teat-treating time under an atmosphere at a pressure less than atmospheric pressure is 0.5 to 20 hours.

After the heat treatment, the carbon nanotube thin film is removed from the heat-treating furnace to obtain a sheet-shaped carbon nanotube unwoven cloth. If the sheet is heat treated with a wound-up cylindrical body, the carbon nanotube thin film, wound up on the cylindrical body, may be released and cut out in a shape of the sheet. The resultant carbon nanotube unwoven cloth may be used in a shape of the sheet, or a shape of roll in which the carbon nanotube unwoven cloth is wound up on a cylindrical body that is made of, for example, paper. Further, a plurality of the resultant carbon nanotube unwoven clothes may be stacked and laminated with each other under pressure to obtain an unwoven cloth having a desired thickness.

The method of the present invention can readily and productively produce a continuous unwoven cloth having a width of 10 to 150 cm and a length greater than or equal to 1 m, and/or sheets cut to a fixed length.

The carbon nanotube unwoven cloth may be surface-treated using silanes (silane coupling agents) or metallic alkoxides. In this case, after the step 5), the carbon nanotube unwoven cloth may be immersed in an aqueous solution containing, for example, silane or in an organic solvent containing polysilazane, and then subjected to heat treatment to thereby perform the surface treatment in an easy manner.

A preferable example of such a silane coupling agent includes a compound represented by a general formula Y—Si—X₃. Here, Y is an organic group having a functional group such as an amino group, an epoxy group, a hydroxyl group, a carboxyl group, a vinyl group, a methacrylic group and a mercapto group; X is a hydrolyzable functional group such as an alkoxy group.

Specific and typical examples of the compound represented by the general formula Y—Si—X₃ include γ-glycidoxypropyltrimethoxysilane, vinyltriethoxysilane, γ-aminopropyltriethoxysilane, γ-mercaptopropyltrimethoxysilane, γ-methacryloxypropyltrimethoxysilane, γ-aminobenzyltriethoxysilane, and γ-aminophenyltriethoxysilane.

Amino silanes are preferable for the silane coupling agent to be used as a surface treatment agent of the carbon nanotube unwoven cloth.

The carbon nanotube unwoven cloth produced in this way does not litter carbon nanotubes on a nanoscale, and is safe and easy to use. Further, when producing a composite material in which the carbon nanotubes are impregnated with resin, such composite material also exhibits improved adhesiveness to resins, and results in enhancement in rupture strength and toughness.

The content of cholic acid derivative, contained in the carbon nanotube unwoven cloth obtained by the production method of the present invention, is from 0% by mass to less than 10% by mass, preferably less than or equal to 0.1% by mass, and more preferably less than or equal to 0.01% by mass.

The content of cholic acid derivative (residual amount) in the carbon nanotube unwoven cloth can be calculated based on a change in weight before and after the measurement using a simultaneous thermogravimetric analyzer that is set under a condition that is identical to the condition in the step 5) for the carbon nanotube thin film obtained in the step 4).

Further, it is preferred that the sodium atom content in the carbon nanotube unwoven cloth obtained from the production method of the present invention be less than or equal to 1.0% by mass. The sodium atom content in the carbon nanotube unwoven cloth may be determined using energy dispersive X-ray spectroscopy.

It is preferred that the carbon nanotube unwoven cloth have a longitudinal/lateral tensile strength ratio of 0.95 to 1.05, more preferably 0.97 to 1.03. The ratios within these ranges result in a structural material for the composite material, which has high strength and is tough and strong in terms of impact strength.

Further, the tensile strength refers to a measured value of tensile strength that is performed on a test piece that is cut out from the unwoven cloth and has a size of 10 mm by 100 mm in which the value is measured using a tensile tester under conditions of gripping width 50 mm and tensile speed 100 mm/min. Specifically, the term “longitudinal tensile strength” refers to a measured value of tensile strength that is performed on a test piece that is cut out in the longitudinal direction from the carbon nanotube unwoven cloth while the term “lateral tensile strength” refers to a measured value of tensile strength that is performed on a test piece that is cut out in the lateral direction from the carbon nanotube unwoven cloth.

The term “longitudinal/lateral tensile strength ratio” as used herein refers to a value determined as a ratio of the longitudinal tensile strength to the lateral tensile strength based on the average values of the longitudinal tensile strength and lateral tensile strength respectively measured by three times.

The term “longitudinal direction” refers to the direction of coating the carbon nanotube water dispersion in the step 4) and the term “lateral direction” refers to a width direction of coating carbon nanotube water dispersion (a direction perpendicular to the direction of coating carbon nanotube dispersion) in the step 4).

### [Composite Material]

The carbon nanotube unwoven cloth of the present invention may be impregnated with a resin to form a composite material.

Examples of resin binders for use in the composite material include a thermosetting resin and a thermoplastic resin. Examples of the thermosetting resin include an epoxy resin, a phenolic resin, a silicone resin, a maleimide resin, a polyimide resin and a bismaleimide resin. Examples of the thermoplastic resin include polyethylene, polypropylene, polyethylene terephthalate, polyester and fluorocarbon resin.

Further, the carbon nanotube unwoven cloth of the present invention may be laminated with a carbon fiber cloth and/or a glass cloth to form a composite material compounded with the resin. Such composite material exhibits a high strength and is a material that is tough and strong in terms of impact strength.

The carbon nanotube unwoven cloth of the present invention is excellent in electric conductivity, and therefore exhibits a superior performance as an electromagnetic shielding material in a wide range of frequency from several hertz to a gigahertz band frequency range.

### WORKING EXAMPLES

The present invention is described in greater detail hereunder with reference to working examples, and the invention shall not be limited to these working examples. In the present invention, “part(s)” refers to “part(s) by mass”.

The materials used in the working as well as comparative examples are as follows. Further, the physical properties and characteristic values in the present invention were measured by the following methods.

### <Carbon Nanotube>

(1) Single-walled carbon nanotubes: EC-1.5P by Meijo Nano Carbon Co., Ltd
(2) Multi-walled carbon nanotubes: EC-2.0P by Meijo Nano Carbon Co., Ltd

### <Basic Compound>

(1) Aqueous ammonia (1 mol/L): a product by FUJIFILM Wako Pure Chemical Corporation
(2) Ethylenediamine: a product by FUJIFILM Wako Pure Chemical Corporation

### <Cholic Acid Derivative>

(1) Cholic acid: a product by FUJIFILM Wako Pure Chemical Corporation
(2) Deoxycholic acid: a product by FUJIFILM Wako Pure Chemical Corporation
(3) Ursodeoxycholic acid: a product by FUJIFILM Wako Pure Chemical Corporation
(4) Chenodeoxycholic acid: a product by FUJIFILM Wako Pure Chemical Corporation
(5) Sodium deoxycholate: a product by FUJIFILM Wako Pure Chemical Corporation

### 1. Method for Measuring pH

The liquid to be measured was left to stand in a thermostatic bath at 25° C. for 1 hour, and then the pH was measured using a pH meter (PHD-210P by Horiba, Ltd.).

### 2. Method for Measuring Thixotropic Ratio

A viscosity (η_{0.1}) at a shear rate of 0.1 s⁻¹ and a viscosity (η₁₀₀) at a shear rate of 100 s⁻¹ of the carbon nanotube water dispersion were respectively measured to determine a thixotropic ratio calculated as η_{0.1}/η₁₀₀. DV-III ULTRA Rheometer manufactured by Brookfield Corporation in combination with a φ48 mm parallel cone (500 μm) was used to measure the respective viscosities at 25° C.

3. Method for measuring Residual Amount of Cholic Acid Derivative

The carbon nanotube thin film obtained in the step 4) in each example was peeled off from the supporting body and the residual amount of cholic acid derivative was determined based on the weight changes before and after the heat treatment.

The weight ratio of carbon nanotubes and cholic acid derivative in the carbon nanotube thin film was assumed to be the same as the weight ratio of carbon nanotubes and cholic acid derivative in the carbon nanotube water dispersion to estimate the amount of residual cholic acid derivative based on the weight loss before and after the heat treatment.

### 4. Method for Measuring Tensile Strength Ratio

Test pieces each having a size of 10 mm by 100 mm were cut out from the unwoven cloth produced as described below, and an autograph (AGS-500NS by SHIMADZU CORPORATION) was used to measure the tensile strength of the unwoven cloth under the conditions of gripping width 50 mm and tensile speed 100 mm/min.

The longitudinal/lateral tensile strength ratio was measured using test pieces that were cut out in the longitudinal and lateral directions which were respectively defined as the direction in which the produced unwoven cloth was coated and the width direction of the coating.

The tensile strength ratio was determined based on the average values of the results of the tests that were performed three times for the longitudinal direction and lateral direction respectively, and a ratio of the longitudinal tensile strength to the lateral tensile strength was determined and defined as the tensile strength ratio.

### 5. Method for Measuring Specific Resistance

The specific resistance thereof was calculated using the following formula:

$$Specific resistance ( Ω \cdot cm ) = Surface resistivity ( Ω / s q . ) \times thickness ( cm ) .$$

The surface resistivity was measured using Loresta-GX MCP-T700 (low resistance, resistivity meter by Nittoseiko Analytech Co., Ltd.). The measured value was then used to calculate the specific resistance.

### 6. Method for Measuring Transmission Loss

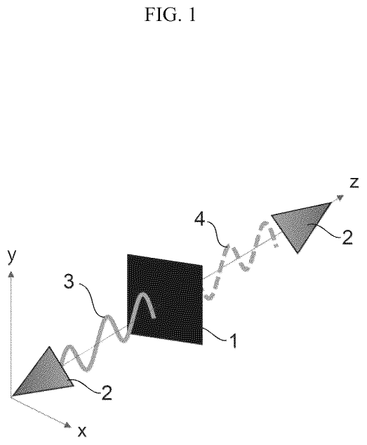

FIG. 1 shows a schematic diagram showing a measurement system for measuring the transmission loss. An electromagnetic wave shield measurement device manufactured by KEYCOM Corporation was used to measure a transmission loss at 70 GHz of the carbon nanotube unwoven cloth or the composite material which was used as a measurement sample. For electromagnetic waves with an oscillating electric field in the y-axis direction, the “longitudinal transmission loss” was measured by setting up the measurement sample so that the longitudinal direction of the sample is arranged in parallel with the y-axis, and the “lateral transmission loss” was measured by setting up the measurement sample so that the longitudinal direction of the sample is arranged to be orthogonal to the y-axis, from which the ratio of the longitudinal to lateral transmission loss was calculated.

### Working Example 1

2.5 parts by mass of aqueous ammonia having an ammonia concentration of 1 mol/L was mixed into 100 parts by mass of water to prepare a basic aqueous solution having a pH of 10. Into a beaker containing the basic aqueous solution was added 0.4 parts by mass of cholic acid serving as a dispersant, which was stirred using a mixer (IFM-800DGM manufactured by Iwatani Corporation) until the cholic acid was entirely dissolved therein to obtain a dispersing aqueous solution. Into this dispersing aqueous solution were added 0.4 parts by mass of single-walled carbon nanotubes, which were then mixed using a mixer for 1 minute at 20,000 rpm to produce a carbon nanotube water dispersion.

The carbon nanotube water dispersion exhibited a viscosity of 237 Pa·s under a low shear condition at a shear rate of 0.1 s⁻¹, while the dispersion also exhibited a viscosity of 0.27 Pa·s under a high shear condition at a shear rate of 100 s⁻¹.

### Working Examples 2 to 12

Eleven types of carbon nanotube water dispersion were produced by mixing the respective components in accordance with the method of the working example 1 except that the basic aqueous solution, the cholic acid derivative and the carbon nanotubes in amounts as indicated in Table 1 were used.

### Working Example 13

0.4 parts by mass of deoxycholic acid as a dispersant was mixed into 100 parts by mass of water to prepare a deoxycholic acid dispersion. To this deoxycholic acid dispersion was added 2.5 parts by mass of aqueous ammonia having an ammonia concentration of 1 mol/L, and the mixture was stirred using a mixer (IFM-800DGM manufactured by Iwatani Corporation) until the deoxycholic acid was entirely dissolved therein to obtain a dispersing aqueous solution. Into this dispersing aqueous solution were added 0.4 parts by mass of single-walled carbon nanotubes, which were then mixed using a mixer for 1 minute at 20,000 rpm to produce a carbon nanotube water dispersion.

The pHs in the basic aqueous solution or dispersing aqueous solution as well as shear viscosities of the carbon nanotube water dispersion in each of the working examples were measured using the methods as shown above, from which thixotropic ratios were calculated based on the measurement results of the shear viscosities. The results are shown in Table 1.

TABLE 1

| | | | Working Examples | | | | | | |
|---|---|---|---|---|---|---|---|---|---|
| | | | 1 | 2 | 3 | 4 | 5 | 6 | 7 |
| Dispersion | Basic | Water | 100 | 100 | 100 | 100 | 100 | 100 | 100 |
| | aqueous | Aqueous ammonia | 2.5 | 2.5 | 2.5 | 2.5 | 8.0 | | 1.3 |
| | solution | (1 mol/L) | | | | | | | |
| | | Ammonia content | 0.043 | 0.043 | 0.043 | 0.043 | 0.136 | | 0.022 |
| | | (parts by mass) | | | | | | | |
| | | Ethylenediamine | | | | | | 0.15 | |
| | Dispersant | Cholic acid | 0.4 | | | | | | |
| | | Deoxycholic acid | | 0.4 | | | 1.3 | 0.4 | 0.2 |
| | | Ursodeoxycholic | | | 0.4 | | | | |
| | | acid | | | | | | | |
| | | Chenodeoxycholic | | | | 0.4 | | | |
| | | acid | | | | | | | |
| | | Sodium | | | | | | | |
| | | deoxycholate | | | | | | | |
| | CNT | Single-walled | 0.4 | 0.4 | 0.4 | 0.4 | | 0.4 | 0.4 |
| | | carbon nanotube | | | | | | | |
| | | Multi-walled | | | | | 0.7 | | |
| | | carbon nanotube | | | | | | | |

| ID number of Carbon nanotube | | 1 | 2 | 3 | 4 | 5 | 6 | 7 |
|---|---|---|---|---|---|---|---|---|
| water dispersion | | | | | | | | |
| Dispersant/Carbon nanotube | | 1.0 | 1.0 | 1.0 | 1.0 | 1.9 | 1.0 | 0.5 |
| (Parts by mass/Parts by mass) | | | | | | | | |
| pH | | 10 | 10 | 10 | 10 | 11 | 10 | 11 |
| Thixotropic ratio of dispersion | | 878 | 319 | 927 | 757 | 296 | 433 | 797 |
| Shear viscosity | 0.1/s | 237 | 83 | 204 | 174 | 163 | 104 | 287 |
| (Pa · s) | 100/s | 0.27 | 0.26 | 0.22 | 0.23 | 0.55 | 0.24 | 0.36 |

| | | | | | | | |
|---|---|---|---|---|---|---|---|
| Sodium atom presence in the dispersion | None | None | None | None | None | None | None |

| | | | Working Examples | | | | | |
|---|---|---|---|---|---|---|---|---|
| | | | 8 | 9 | 10 | 11 | 12 | 13 |
| Dispersion | Basic | Water | 100 | 100 | 100 | 100 | 100 | 100 |
| | aqueous | Aqueous ammonia | 30 | 30 | 60 | 30 | 15 | 2.5 |
| | solution | (1 mol/L) | | | | | | |
| | | Ammonia content | 0.54 | 0.54 | 1.00 | 0.54 | 0.27 | 0.043 |
| | | (parts by mass) | | | | | | |
| | | Ethylenediamine | | | | | | |
| | Dispersant | Cholic acid | | | | | | |
| | | Deoxycholic acid | 5 | | | 5 | 2.5 | 0.4 |
| | | Ursodeoxycholic | | 5 | | | | |
| | | acid | | | | | | |
| | | Chenodeoxycholic | | | 10 | | | |
| | | acid | | | | | | |
| | | Sodium | | | | | | |
| | | deoxycholate | | | | | | |
| | CNT | Single-walled | 5 | | | | 5 | 0.4 |
| | | carbon nanotube | | | | | | |
| | | Multi-walled | | 5 | 10 | 10 | | |
| | | carbon nanotube | | | | | | |

| ID number of Carbon nanotube | | 8 | 9 | 10 | 11 | 12 | 13 |
|---|---|---|---|---|---|---|---|
| water dispersion | | | | | | | |
| Dispersant/Carbon nanotube | | 1.0 | 1.0 | 1.0 | 0.5 | 0.5 | 1.0 |
| (Parts by mass/Parts by mass) | | | | | | | |
| pH | | 11 | 11 | 12 | 11 | 11 | 10 |
| Thixotropic ratio of dispersion | | 335 | 881 | 782 | 773 | 390 | 409 |
| Shear viscosity | 0.1/s | 1040 | 2380 | 3050 | 3560 | 1720 | 94 |
| (Pa · s) | 100/s | 3.1 | 2.7 | 3.9 | 4.6 | 4.4 | 0.23 |

| | | | | | | |
|---|---|---|---|---|---|---|
| Sodium atom presence in the dispersion | None | None | None | None | None | None |

### Comparative Example 1

0.4 parts by mass of deoxycholic acid was added as a dispersant into a beaker containing 100 parts by mass of water having no ammonia and pH of 7 in place of the basic aqueous solution of the working example 2, and then the mixture was stirred. The deoxycholic acid was not entirely dissolved therein. Into this dispersing aqueous solution was added 0.4 parts by mass of single-walled carbon nanotubes, which were mixed using a mixer for 1 minute at 20,000 rpm to produce a carbon nanotube water dispersion.

The carbon nanotubes in this carbon nanotube water dispersion consistently formed aggregates having sizes that could be visually recognized, which therefore indicates that the dispersibility was inadequate.

### Comparative Example 2

0.4 parts by mass of sodium deoxycholate as a dispersant was added into a beaker containing 100 parts by mass of water having no ammonia and pH of 7, and then the mixture was stirred until the sodium deoxycholate was entirely dissolved therein. Into this dispersing aqueous solution was added 0.4 parts by mass of single-walled carbon nanotubes, which were then mixed using a mixer for 1 minute at 20,000 rpm to produce a carbon nanotube water dispersion.

The carbon nanotube water dispersion exhibited a viscosity of 122 Pa·s under a low shear condition at a shear rate of 0.1 s⁻¹, while the dispersion also exhibited a viscosity of 0.27 Pa·s under a high shear condition at a shear rate of 100 s⁻¹.

### Comparative Example 3

1.0 parts by mass of aqueous ammonia having an ammonia concentration of 1 mol/L was mixed into 100 parts by mass of water to prepare a basic aqueous solution having a pH of 9.

Into a beaker containing the basic aqueous solution was added 0.02 parts by mass of deoxycholic acid as a dispersant, which was stirred using a mixer (IFM-800DGM manufactured by Iwatani Corporation) until the deoxycholic acid was entirely dissolved therein to obtain a dispersing aqueous solution. Into this dispersing aqueous solution were added 0.4 parts by mass of single-walled carbon nanotubes, which were then mixed using a mixer for 1 minute at 20,000 rpm to produce a carbon nanotube water dispersion.

The carbon nanotubes in this carbon nanotube water dispersion consistently formed aggregates having sizes that could be visually recognized, which therefore indicates that the dispersibility was inadequate.

### Comparative Example 4

Into 100 parts by mass of water was mixed 8.0 parts by mass of aqueous ammonia having an ammonia concentration of 1 mol/L to prepare a basic aqueous solution having a pH of 11. Into a beaker containing the basic aqueous solution was added 1.0 parts by mass of deoxycholic acid as a dispersant, which was stirred using a mixer (IFM-800DGM manufactured by Iwatani Corporation) until the deoxycholic acid was entirely dissolved therein to obtain a dispersing aqueous solution. Into this dispersing aqueous solution were added 0.4 parts by mass of single-walled carbon nanotubes, which were then mixed using a mixer for 1 minute at 20,000 rpm to produce a carbon nanotube water dispersion.

The carbon nanotube water dispersion exhibited a viscosity of 4.95 Pa·s under a low shear condition at a shear rate of 0.1 s⁻¹, while the dispersion also exhibited a viscosity of 0.11 Pa·s under a high shear condition at a shear rate of 100 s⁻¹.

### Comparative Example 5

In a similar manner as the working example 1, into a beaker containing the basic aqueous solution having a pH of 10 in the working example 1 was added 0.4 parts by mass of deoxycholic acid as a dispersant, which was then stirred until the deoxycholic acid was entirely dissolved therein to obtain a dispersing aqueous solution. Into this dispersing aqueous solution were added 12 parts by mass of multi-walled carbon nanotubes, which were then mixed using a mixer for 1 minute at 20,000 rpm to produce a carbon nanotube water dispersion.

This carbon nanotube water dispersion exhibited a viscosity of 2780 Pa·s under a low shear condition at a shear rate of 0.1 s⁻¹, while the dispersion also exhibited a viscosity of 2.6 Pa·s under a high shear condition at a shear rate of 100 s⁻¹.

The pHs in the basic aqueous solution or dispersion medium as well as shear viscosities of the carbon nanotube water dispersion in each of the comparative examples were measured using the methods as shown above, from which thixotropic ratios were calculated based on the measurement results of the shear viscosities. The results are shown in Table 2.

TABLE 2

| | | | Comparative Examples | | | | |
|---|---|---|---|---|---|---|---|
| | | | 1 | 2 | 3 | 4 | 5 |
| Dispersion | Basic | Water | 100 | 100 | 100 | 100 | 100 |
| | aqueous | Aqueous ammonia | | | 1.0 | 8.0 | 2.5 |
| | solution | (1 mol/L) | | | | | |
| | | Ammonia content | | | 0.017 | 0.136 | 0.043 |
| | | (parts by mass) | | | | | |
| | | Ethylenediamine | | | | | |
| | Dispersant | Cholic acid | | | | | |
| | | Deoxycholic acid | 0.4 | | 0.02 | 1.0 | 0.4 |
| | | Ursodeoxycholic acid | | | | | |
| | | Chenodeoxycholic acid | | | | | |
| | | Sodium deoxycholate | | 0.4 | | | |
| | CNT | Single-walled carbon | 0.4 | 0.4 | 0.4 | 0.1 | |
| | | nanotube | | | | | |
| | | Multi-walled carbon | | | | | 12 |
| | | nanotube | | | | | |

| ID number of Carbon nanotube water dispersion | | 14 | 15 | 16 | 17 | 18 |
|---|---|---|---|---|---|---|
| Dispersant/Carbon nanotube | | 1.0 | 1.0 | 0.05 | 10.0 | 0.03 |
| (Parts by mass/Parts by mass) | | | | | | |
| pH | | 7 | 7 | 9 | 11 | 10 |
| Thixotropic ratio of dispersion | | | 452 | | 45 | 1070 |
| Shear viscosity | 0.1/s | | 122 | | 4.95 | 2780 |
| (Pa · s) | 100/s | | 0.27 | | 0.11 | 2.6 |

| | | | | | |
|---|---|---|---|---|---|
| Sodium atom presence in the dispersion | None | Present | None | None | None |

Next, the carbon nanotube water dispersions produced in the working examples were used to produce carbon nanotube unwoven clothes in accordance with the wet method.

### Working Example 14

The carbon nanotube water dispersion produced in the working example 1 was applied using a die coater (manufactured by ERS Inc.) onto a fluorocarbon resin film (Trade name: AFLEX; manufactured by AGC chemical company) of the supporting body with the thickness of 1 mm, coating width of 28 cm and length of 30 m. The coated product was dried by moving the product at 20 cm/min through a drying oven heated to a temperature of 150° C.

The dried carbon nanotube thin film on the fluorocarbon resin film was peeled off from the fluorocarbon resin film, and the carbon nanotube thin film was reeled off at the thickness of 3 mm on a cylindrical body (hereafter also referred to as “iron tube”) which is made of iron and has an outer diameter of 100 mm, a thickness of 10 mm and a plurality of through-holes in the sidewall. This iron tube was put into a heating furnace heated to 300° C. under nitrogen atmosphere and heated for 14 hours while feeding nitrogen to produce a carbon nanotube unwoven cloth (1) from which cholic acid, ammonia and/or other impurities were removed.

### Working Examples 15 to 19

Carbon nanotube water dispersions produced in the working examples 2, 4, 7, 10 and 12 were used to perform coating, drying and heat treatment under the same condition as the working example 14 to produce unwoven cloths 2 to 6.

### Working Examples 20 and 21

Carbon nanotube unwoven cloths 7 and 8 were produced under the same conditions as the working example 15, except the heat treatment conditions as shown in Table 3 were used.

The physical properties of carbon nanotubes in each working example were measured by the methods explained above. These results are shown in Table 3.

TABLE 3

| | | Working Examples | | | | | | | |
|---|---|---|---|---|---|---|---|---|---|
| | | 14 | 15 | 16 | 17 | 18 | 19 | 20 | 21 |
| ID number of Carbon nanotube | | 1 | 2 | 4 | 7 | 10 | 12 | 2 | 2 |
| water dispersion | | | | | | | | | |
| Heat | Temperature (° C.) | 300 | | | | | | 400 | 300 |
| treatment | Time (hrs.) | 14 | | | | | | 5 | 24 |
| | Atmosphere | Nitrogen | | | | | | | Vacuum |
| | Pressure | Atmospheric pressure | | | | | | | 5 Pa · s |
| ID number of Carbon nanotube | | 1 | 2 | 3 | 4 | 5 | 6 | 7 | 8 |
| unwoven cloth | | | | | | | | | |
| Physical | Residual amount of | 5 | 5 | 4 | 9 | 8 | 8 | 3 | 9 |
| properties | cholic acid derivative | | | | | | | | |
| of unwoven | (% by mass) | | | | | | | | |
| cloth | Longitudinal/lateral | 0.97 | 0.99 | 1.02 | 0.96 | 1.05 | 1.01 | 1.0 | 0.95 |
| | tensile strength ratio | | | | | | | | |
| | Specific resistance | 8.22 | 6.93 | 8.27 | 11.7 | 28.4 | 36.5 | 9.63 | 7.54 |
| | (E-04 Ω · cm) | | | | | | | | |
| | Longitudinal/lateral | 1.05 | 1.2 | 0.99 | 0.98 | 0.93 | 1.1 | 0.94 | 0.94 |
| | transmission loss ratio | | | | | | | | |

### Comparative Example 6

Carbon nanotube unwoven cloth 9 was produced under the same conditions as the working example 15, except the heat treatment conditions as shown in Table 4 were used.

### Comparative Example 7

Carbon nanotube unwoven cloth 10 was produced under the same conditions as the working example 15, except the heat treatment conditions as shown in Table 4 were used.

### Comparative Example 8

Carbon nanotube unwoven cloth 11 was produced under the same conditions as the working example 15, except the heat treatment conditions as shown in Table 4 were used.

The thermogravimetry showed results indicating weight losses of amounts greater than the contents of cholic acid derivatives, which therefore implies that the carbon nanotubes were partially oxidized or deteriorated.

Physical properties of carbon nanotubes in each comparative example were measured by the methods as explained above. These results are shown in Table 4.

TABLE 4

| | | Comparative Examples | | |
|---|---|---|---|---|
| | | 6 | 7 | 8 |
| ID number of Carbon nanotube water dispersion | | 2 | 2 | 2 |
| Heat | Temperature (° C.) | 200 | 100 | 600 |
| treatment | Time (hrs.) | 24 | 5 | 5 |
| | Atmosphere | Nitrogen | Vacuum | Nitrogen |
| | Pressure | Atmospheric | 5 Pa · s | Atmospheric |
| | | pressure | | pressure |
| ID number of Carbon nanotube unwoven cloth | | 9 | 10 | 11 |
| Physical | Residual amount of cholic acid | 12 | 10 | −11 |
| properties of | derivative (% by mass) | | | |
| unwoven | Longitudinal/lateral tensile strength ratio | 0.99 | 1.0 | 0.88 |
| cloth | Specific resistance (E−04 (Ω · cm) | 3.34 | 5.35 | 45.2 |
| | Longitudinal / lateral transmission | 1.1 | 0.92 | 0.98 |
| | loss ratio | | | |

Further, attempts were made for producing carbon nanotube unwoven clothes by the wet method using the carbon nanotube water dispersions produced in the comparative examples 1 to 5. It turned out that the carbon nanotube water dispersions 14, 16 and 18 of the comparative examples 1, 3 and 5 exhibited poor dispersibility of carbon nanotubes, which caused an issue that uniform carbon nanotube thin films were prevented from being formed when these dispersions were applied to the respective supporting bodies or that the films were broken when they were peeled off from the respective supporting bodies.

The carbon nanotube water dispersion 15 of the comparative example 2 contains sodium atoms, which therefore makes an unwoven cloth, made from this dispersion, hydrophilic because of the presence of sodium atoms in the unwoven cloth, and cause a problem such as deterioration in resin when producing composite material.

Also, the carbon nanotube water dispersion 15 produced in the comparative example 2 was used to perform coating, drying and heat treatment under the same conditions as the working example 14 to produce an unwoven cloth. Sodium atom content in this unwoven cloth was determined using energy dispersive X-ray spectroscopy, and it turned out that the content of sodium atom was 8.3% by mass.

Further, the carbon nanotube water dispersion 17 produced in the comparative example 4 had a large amount of cholic acid derivative with respect to the amount of carbon nanotubes, and had poor thixotropy, which prevented a uniform carbon nanotube film from being formed on a supporting body and therefore no carbon nanotube unwoven cloth having a uniform thickness could be formed. In addition, since this carbon nanotube water dispersion contained a large amount of cholic acid derivative, it would be necessary to increase the heating temperature or prolong the heating time in the heat treatment step for removing the derivative, which may be undesirable as it may cause oxidative deterioration of the carbon nanotubes.

Next, various types of composite material were produced using the carbon nanotube unwoven cloth produced in the working example 14.

### Application Example 1

There was prepared a toluene solution comprised of 100 parts by mass of a bismaleimide resin (A-1) (SLK-3000 by Shin-Etsu Chemical Co., Ltd.), 1 part by mass of a curing catalyst (dicumylperoxide, “PERCUMYL D” by NOF CORPORATION), and 200 parts by mass of toluene.

By impregnating the carbon nanotube unwoven cloth prepared in the working example 14 with this toluene solution and then removing toluene by drying, there was produced an unwoven cloth impregnated with a semi-cured bismaleimide resin.

This unwoven cloth was then pressurized and cured at 150° C. for 30 min using a pressing device, thereby producing a resin-impregnated unwoven cloth sheet. The sheet had a thickness of 65 μm.

Using this sheet, transmission losses in the longitudinal and lateral directions were measured. In addition, test pieces of unwoven cloth sheet were cut out from the longitudinal and lateral directions of the unwoven cloth sheet to measure the respective tensile strengths. The measured results are shown in Table 5.

### Application Example 2

A carbon fiber prepreg (TR3110 manufactured by Mitsubishi Chemical Corporation) was placed on both surfaces of the bismaleimide resin-impregnated unwoven cloth prepreg produced in the application example 1 so as to laminate them in three layers. A hot press set to a temperature of 200° C. was then used to heat them and cure the laminate for 30 min, thereby obtaining a three-layered carbon nanotube unwoven cloth composite sheet.

Using this sheet, transmission losses in the longitudinal and lateral directions were measured. In addition, test pieces of unwoven cloth sheet were cut out from the longitudinal and lateral directions of the unwoven cloth sheet to measure the respective tensile strengths. The measured results are shown in Table 5.

### Application Example 3

A glass cloth prepreg produced by impregnating a glass cloth fabric having a thickness of 50 μm and plain-woven by T glass yarns (IPC name: D450) as set forth in JIS R3413 impregnated with a toluene solution of the bismaleimide resin in the application example 1 was placed on both surfaces of the bismaleimide resin-impregnated unwoven cloth prepreg produced in the application example 1 so as to laminate them in three layers in a similar manner as the application example 1. A hot press set to a temperature of 200° C. was then used to heat them and cure the laminate for 30 min, thereby obtaining a three-layered carbon nanotube unwoven cloth composite sheet.

Using this sheet, transmission losses in the longitudinal and lateral directions were measured. In addition, test pieces of unwoven cloth sheet were cut out from the longitudinal and lateral directions of the unwoven cloth sheet to measure the respective tensile strengths. The measured results are shown in Table 5.

TABLE 5

| | Application | Application | Application |
|---|---|---|---|
| | Example 1 | Example 2 | Example 3 |
| Longitudinal / lateral | 0.98 | 1.2 | 1.1 |
| transmission loss ratio | | | |
| Longitudinal / lateral tensile | 1.02 | 0.97 | 1.03 |
| strength ratio | | | |

### REFERENCE NUMERAL

1 Test sample
2 Antenna
3 Incident wave
4 Transmitting wave

What is claimed is:

1. A carbon nanotube water dispersion comprising:
100 parts by mass of water;
0.001 parts by mass or more of a basic compound;
0.001 parts by mass or more of a cholic acid derivative; and
0.01 to 10.0 parts by mass of carbon nanotubes,
wherein an amount by mass of the cholic acid derivative with respect to an amount by mass of the carbon nanotubes is 0.1 to 5.0.

2. The carbon nanotube water dispersion according to claim 1, wherein the cholic acid derivative is one or more selected from the group consisting of α-muricholic acid, β-muricholic acid, cholic acid, deoxycholic acid, ursodeoxycholic acid, hyodeoxycholic acid, chenodeoxycholic acid, dehydrocholic acid, and lithocholic acid.

3. The carbon nanotube water dispersion according to claim 1, wherein the basic compound is a nitrogen-containing compound.

4. The carbon nanotube water dispersion according to claim 3, wherein the nitrogen-containing compound is ammonia.

5. The carbon nanotube water dispersion according to claim 1, wherein the carbon nanotube water dispersion has a thixotropic ratio of 50 to 1,000, wherein the thixotropic ratio is a ratio (η_{0.1}/η₁₀₀) of a viscosity (η_{0.1}) at a shear rate of 0.1 s⁻¹ to a viscosity (η₁₀₀) at a shear rate of 100 s⁻¹, wherein the viscosities (η_{0.1}, η₁₀₀) are measured at 25° C. using a cone-plate type rotary viscometer described in JIS K 7117-2:1999.

6. A method of producing a carbon nanotube water dispersion comprising the steps of:
preparing a dispersing aqueous solution containing:
100 parts by mass of water;
0.001 parts by mass or more of a basic compound; and
0.001 parts by mass or more of a cholic acid derivative; and
dispersing 0.01 to 10.0 parts by mass of carbon nanotubes into the dispersing aqueous solution such that an additive amount by mass of the cholic acid derivative to an amount by mass of the carbon nanotubes is 0.1 to 5.0.

7. The method according to claim 6, wherein the step of preparing a dispersing aqueous solution comprises
1) adding 0.001 parts by mass or more of a basic compound into 100 parts by mass of water and mixing the ingredients to prepare a basic aqueous solution having a pH of 8 to 12; and
2) dissolving 0.001 parts by mass or more of a cholic acid derivative into the basic aqueous solution to prepare a dispersing aqueous solution.

8. A method of producing a carbon nanotube unwoven cloth comprising the steps of:
4) applying the carbon nanotube water dispersion according to claim 1 to a supporting body by a thickness of 5 mm or less, and removing water in a drying oven to produce a carbon nanotube thin film; and
5) separating the carbon nanotube thin film obtained in the step 4) from the supporting body and subjecting the thin film to a heat treatment of 250 to 500° C. at atmospheric pressure or to a heat treatment of 150 to 500° C. at a pressure less than the atmospheric pressure,
wherein the carbon nanotube unwoven cloth contains from 0% to less than 10% by mass of the cholic acid derivative.

9. The method according to claim 8, wherein the heat treatment is performed in an inert gas.

10. A carbon nanotube unwoven cloth comprising a sodium atom content of less than or equal to 1.0% by mass.

11. The carbon nanotube unwoven cloth according to claim 10, wherein the carbon nanotube unwoven cloth has a tensile strength ratio, as defined by a ratio of a longitudinal tensile strength to a lateral tensile strength, of 0.95 to 1.05.
